(19) United States
(12) Patent Application Publication
(10) Pub. No.: US 2021/0182730 A1
(43) Pub. Date: Jun. 17, 2021

(54) SYSTEMS AND METHODS FOR DETECTING NON-CAUSAL DEPENDENCIES IN MACHINE LEARNING MODELS

(71) Applicant: SHOPIFY INC., OTTAWA (CA)

(72) Inventor: GREGORY CLARKE, OTTAWA (CA)

(21) Appl. No.: 16/711,538

(22) Filed: Dec. 12, 2019

(51) Int. Cl. G06N 20/00

(52) U.S. Cl. CPC G06N 20/00

(57) ABSTRACT

A non-causal dependency in a machine learning model can bias the performance of the machine learning model. Systems and methods for detecting non-causal dependencies in machine learning models are provided. According to an embodiment, a method includes generating a plurality of data samples from a particular data sample, the plurality of data samples including a modified data sample that differs from the particular data sample by non-causal data, the non-causal data having a non-causal relationship to the output of a machine learning model. The method also includes generating a plurality of results by inputting the plurality of data samples into the machine learning model. The method further includes determining, based on a comparison of the plurality of results, if the machine learning model is dependent on the non-causal data.

### FIELD

The present application relates to computer-implemented machine learning models, and in particular embodiments, to testing computer-implemented machine learning models.

### BACKGROUND

Machine learning (ML), a branch of artificial intelligence, involves the use of data to train algorithms or models. During training, an ML model can identify patterns in a data set that includes input data and known results. The trained ML model can then receive input data and predict a result or make a decision based on the input data and the patterns identified by the ML model during training.

Bias is a common problem in ML models. While an ML algorithm might not be inherently biased, an ML model produced through the algorithm can become biased during training. For example, bias may exist in the data set that is used to train an ML model, and this bias may be reflected in the ML model after training. Bias is the systematic prejudice against one thing, person, or group compared with another. Therefore, bias is typically undesirable in an ML model.

### SUMMARY

Aspects of the present disclosure relate to computer-implemented methods for detecting bias and other non-causal dependencies in ML models. Once bias is detected in an ML model, the ML model can be retrained or otherwise updated to reduce or remove the bias. Alternatively, use of the ML model can be restricted to situations in which the effect of the bias is reduced.

According to one aspect of the present disclosure, there is provided a computer-implemented method. The method includes storing, in memory, a machine learning model defining a relationship between input data and an output. The method also includes generating a plurality of data samples from a particular data sample, the plurality of data samples including a modified data sample that differs from the particular data sample by non-causal data, the non-causal data having a non-causal relationship to the output. The method further includes generating a plurality of results by inputting the plurality of data samples into the machine learning model, each of the plurality of results corresponding to a respective data sample of the plurality of data samples. The method further includes determining, based on a comparison of the plurality of results, if the machine learning model is dependent on the non-causal data. A system configured to perform the method is also provided. The system includes a memory to store the machine learning model, and at least one processor to perform some or all of the steps above.

### BRIEF DESCRIPTION OF THE DRAWINGS

Embodiments will be described, by way of example only, with reference to the accompanying figures wherein:

FIG. 1 is a block diagram of an e-commerce platform, according to one embodiment of the present disclosure;

FIG. 2 is an example of a home page of an administrator, according to one embodiment of the present disclosure;

FIG. 3 illustrates the e-commerce platform of FIG. 1, but including a machine learning model test engine;

FIG. 4 is a block diagram illustrating an example system for implementing one or more machine learning models;

FIG. 5 is a flow diagram illustrating an example process for detecting a non-causal dependency in a machine learning model;

FIG. 6 is an example screen page for submitting a product description;

FIG. 7 is an example screen page including the product description of FIG. 6 and an indication of a gender bias in a machine learning model; and

FIG. 8 is a flow diagram illustrating an example computer-implemented method performed by a system.

### DETAILED DESCRIPTION

For illustrative purposes, specific example embodiments will now be explained in greater detail below in conjunction with the figures.

Example e-Commerce Platform

In some embodiments, the methods disclosed herein may be performed on or in association with an e-commerce platform. Therefore, an example of an e-commerce platform will be described.

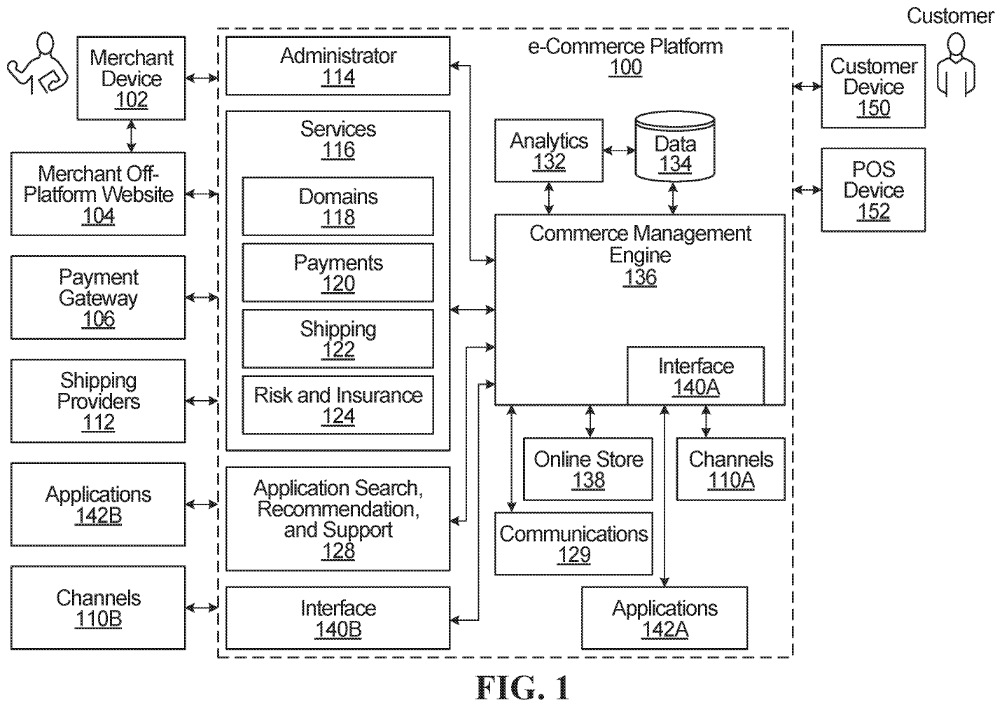

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

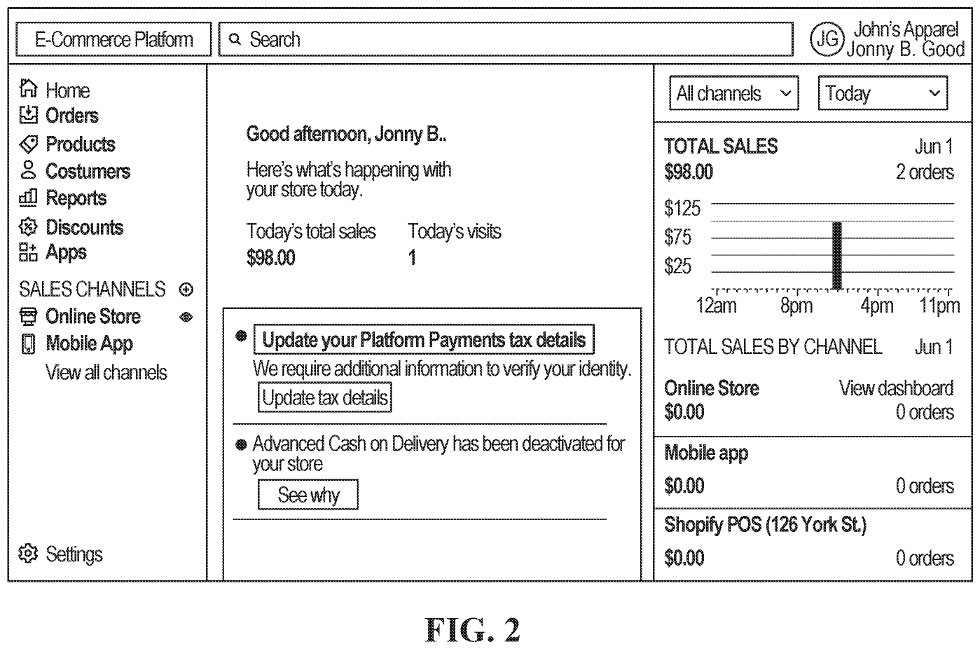

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Implementation of Machine Learning Models in an e-Commerce Platform

Machine learning (ML) models can be applied within an e-commerce platform. In some embodiments, one or more components of the e-commerce platform 100 are implemented at least in part using ML models. For example, a portion of the analytics 132 may be implemented with the help of ML models. The following is a non-limiting list of example applications for ML models in an e-commerce platform:
An ML model can analyse customer data to predict market trends and provide merchants with recommendations for improving sales.
An ML model can analyse a customer's behaviour and recommend products that the customer might be interested in purchasing.
An ML model can analyse sales data to help improve a merchant's pricing strategy. The ML model could receive product supply, seasonality, and demand information as inputs, and output recommendations for adjusting the merchant's prices accordingly.
An ML model can analyse market demand to help a merchant improve their inventory planning and logistics. The ML model could help the merchant avoid waste by managing the storage and transportation of perishable items.
An ML model can analyse delivery costs to help a merchant plan more efficient delivery routes.
An ML model can analyse regional sales data to help a merchant deploy sales staff where they will be more effective.
An ML model can analyse website content and provide a merchant with recommendations for improving the content on their website.
An ML model can analyse a product description or product image and provide a merchant with a recommendation for improving the description/image.
An ML model can analyse previous fraudulent orders and determine trends in fraud. The ML model could warn a merchant when their product, product image or product description might be associated with a high risk of fraud.

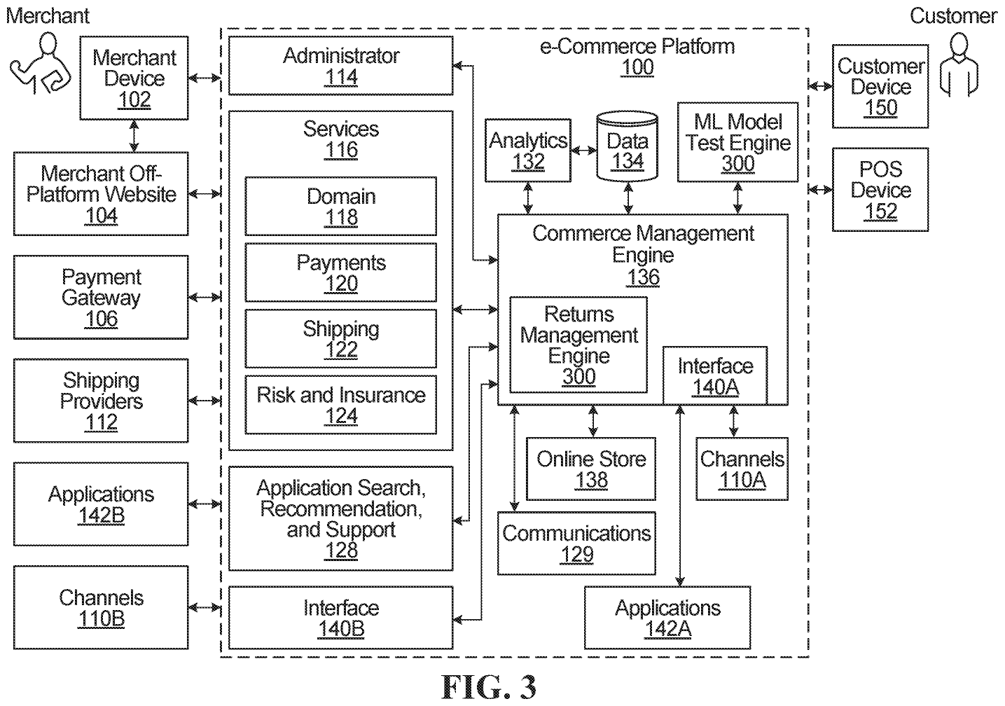

To ensure that an ML model is making accurate predictions and/or making reasonable decisions, the ML model may be tested. Testing can occur once or repeatedly. The e-commerce platform 100 may test any or all of the ML models implemented therein. FIG. 3 illustrates the e-commerce platform 100 of FIG. 1, but including an ML model test engine 300. The ML model test engine 300 is an example of a computer-implemented system that tests the performance of an ML model implemented in the e-commerce platform 100.

By way of example, the ML model test engine 300 could test an ML model using a data sample having input data and known results. The input data includes parameters or variables that are input into the ML model. The known results are measured or observed results that correspond to the input data. Known results are used to indicate what the output of the ML model should be for certain input data. The ML model could receive the input data and generate a result that is then compared to the known result. If the result produced by the ML model substantially matches the known result, then the ML model is considered to have passed the test. This is an indication that the ML model is accurate and properly trained. Alternatively, if the result produced by the ML model differs from the known result by more than a predetermined threshold, then the ML model is considered to have failed the test. This is an indication that the ML model should be subject to further training or retraining.

Although the ML model test engine 300 is illustrated as a distinct component of the e-commerce platform 100 in FIG. 3, this is only an example. An ML model test engine could also or instead be provided by another component of the e-commerce platform 100. In some embodiments, the commerce management engine 136 provides an ML model test engine. Furthermore, in some embodiments, either or both of the applications 142A-B provide an ML model test engine that is available to merchants. The e-commerce platform 100 could include multiple ML model test engines that provide varying functionality.

As discussed in further detail below, the ML model test engine 300 could implement at least some of the functionality described herein. Although the embodiments described below may be implemented in association with the e-commerce platform 100, the embodiments described below are not limited to the specific e-commerce platform 100 of FIGS. 1 to 3. Therefore, the embodiments below will be presented more generally in relation to any e-commerce platform.

### Non-Causal Dependencies in ML Models

An ML model can be trained to define a relationship between input data and an output. After training, the ML model can receive input data from a data sample and produce a result. This result is a particular output that is generated by the ML model from the data sample, where the data sample provides the input data that is processed by the ML model to generate the result. By way of example, consider an ML model that is capable of analysing a picture of a dog to determine the breed of the dog. The output of the ML model is the prediction of the breed, and possible results that may be produced by the ML model include specific breeds such as bulldog, springer spaniel, and greyhound, for example. The ML model could receive a data sample in the form of a photograph of a dog, and produce a result in the form of a prediction of the particular breed of dog in the photograph.

Ideally, an ML model will generate a result based on input data that has a causal relationship to the output of the ML model. Input data that has a non-causal relationship to the output, including data that has no relationship at all to the output, is preferably ignored by the ML model. For example, some input data in a data sample might be correlated with a particular result, but the correlated input data does not directly lead to the result. While it might be possible for an ML model to predict the result based on the correlated input data, a potentially more accurate ML model would instead predict the result based on input data having a causal relationship to the result.

Consider, for example, a model that predicts the number of babies born in a town over the course of a year. The number of babies born is directly dependent on the population of the town, and therefore the population of the town has a causal relationship to the number of babies born. In some cases, there might also be a correlation between the number of babies born in a town and the number of restaurants in the town. This correlation illustrates a non-causal relationship between the number of babies born and the number of restaurants, as both quantities are dependent on the population of the town. Building more restaurants in the town will not lead directly to a change in the number of babies being born in the town. Thus, a model for predicting the number of babies born in a town would be more accurate if dependent on the population of the town, rather than being dependent on the number of restaurants in the town and independent of the population of the town.

In another example, a model predicts whether or not it will rain in a city on a given day. Possible results that can be generated by the model are: “Yes, it will rain today”; and “No, it will not rain today”. There may be a correlation between the probability of rain and the number of people leaving their homes with umbrellas in the morning. This is because the probability of rain has a causal relationship to the number of people who leave their homes with umbrellas, as people bring their umbrellas when they learn that it may rain. In contrast, the number of people who leave their homes with umbrellas has a non-causal relationship to the probability of rain. The chance that it will rain is not dependent on the number of people who leave their homes with umbrellas, and increasing the number of people who leave their homes with umbrellas will not directly change the chance that it will rain that day. It might be possible for the model to predict whether or not it will rain based on the number of people who leave their homes with umbrellas in the morning. However, a model for predicting whether or not it will rain in a city on a given day would be more accurate if dependent on input data that has a causal relationship to the chance of rain (for example, barometric pressure), and independent of the number of people leaving their homes with umbrellas.

In the context of ML models, input data that has a causal relationship with an output is referred to herein as “causal input data”, whereas input data that does not have a causal relationship with an output is referred to herein as “non-causal input data”. Non-causal input data includes input data with no relationship at all to the output and input data that is merely correlated with the output.

The output of an ML is preferably dependent on causal input data and substantially independent of non-causal input data. Adding, removing or modifying causal input data in a data sample should affect the result produced by an ML model for that data sample. In contrast, adding, removing or modifying non-causal input data in a data sample should not substantially affect the result produced by an ML model for that data sample. Any dependency of an ML model on non-causal input data, which is also referred to as a “non-causal dependency”, may degrade the performance of the ML model and could be considered a “bug” in the ML model.

Noise in a data sample is an example of non-causal input data that has no relationship to an output of an ML model. Consider an ML model that is implemented for voice recognition. An input data sample for the ML model includes an audio recording of a voice, but there may also be background noise in the audio recording. The ML model is for voice recognition, and the output of the ML model should be dependent on the voice that is captured in the recording. Therefore, the portion of the audio recording that is related to the voice is considered causal input data. The background noise is non-causal input data and should ideally be ignored by the ML model. However, in some cases, the ML model might be dependent on the background noise. For example, adding or removing the background noise in the audio recording might affect the results produced by the ML model. This is an example of a non-causal dependency in the ML model.

Bias is another example of a non-causal dependency in an ML model. In some cases, biased training data can produce an ML model with non-causal dependencies. For example, consider an ML model that is trained to predict the risk of fraudulent orders being placed for certain products in an e-commerce platform. The ML model is provided with input data samples, including a product name and product description, and the ML model outputs a predicted risk of fraud associated with the product. Bias may exist in the data that is used to train the ML model, which can lead to a bias in the ML model. For example, the ML model could have a gender bias. Gendered terms in a product description (for example, he/she, his/hers, etc.) may correlate with fraud in some cases, but the gendered terms do not cause fraud. Instead, gender and risk of fraud may be linked by an unknown variable that has a causal relationship to the risk of fraud. The accuracy of the ML model could be improved if the unknown variable is determined and used by the ML model to predict the risk of fraud.

Gender is one example of a bias genre; however, many other examples exist, including age, ethnicity and religion. In addition to being a non-causal dependency that can negatively impact the performance of an ML model, bias may also unfairly prejudice certain groups. In an example, the e-commerce platform 100 offers loans to some merchants to help them to grow their business. The e-commerce platform 100 could use an ML model to help determine which merchants have the highest risk of defaulting on their loan. The ML model may determine that the chance a merchant will default on their loan correlates with the merchant's gender, age, ethnicity or religion. However, the e-commerce platform 100 would not want to reject a merchant's application for a loan based solely on the merchant's gender, age, ethnicity or religion. A more fair and accurate approach would be to determine the unknown variable that links the chance a merchant will default on their loan to the merchant's gender, age, ethnicity or religion, and accept or reject a merchant's application for a loan based at least in part on that variable.

Biased values can exist in measurements. In general, a biased value is any component of a measurement that can prejudice or bias the analysis of the measurement. Examples of potential biased values include: the pitch or tone of a voice in an audio recording, the colour of someone's skin or length of their hair in an image, and the background color in an image. In some cases, ML models that analyse measurements may be dependent on biased values in the measurements. Consider again an ML model that is implemented for speech recognition, where an input data sample for the ML model includes an audio recording of a voice. The output of the ML model may be dependent on the tone or pitch of the voice in a received audio recording. This is an example of a non-causal dependency in the ML model, as the pitch or tone of the voice does not have a causal relationship to the words spoken by the voice.

### Detecting Non-Causal Dependencies in ML Models

An aspect of the present disclosure relates to the detection of non-causal dependencies in an ML model. Once detected, the non-causal dependencies can be reduced or even removed by updating the ML model. Given the complexity of some ML models, detecting a dependence or reliance on non-causal input data can be difficult. For example, the relationship between input data and a result produced by an ML model is not always clear from examining the ML model. As such, a need exists for systems and methods to enable the detection of an ML model's dependence on non-causal input data.

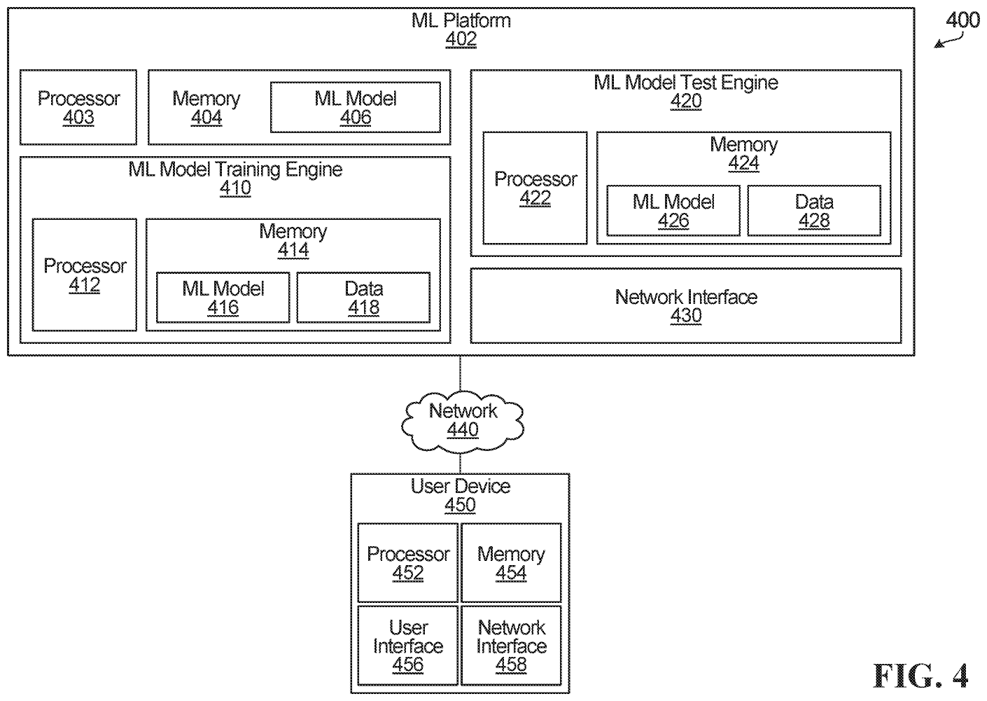

FIG. 4 is a block diagram illustrating an example system 400 for implementing one or more ML models. The system 400 includes an ML platform 402, a network 440, and a user device 450.

The ML platform 402 is a generic platform that includes one or more ML models. The purpose of the ML platform 402 is implementation specific. In some embodiments, the ML platform 402 is an e-commerce platform similar to the e-commerce platform 100 of FIGS. 1 to 3; however, the present disclosure is in no way limited to e-commerce. The ML platform 402 could also be a social media platform or a financial platform, for example.

The ML platform 402 includes a processor 403 and memory 404 that stores an ML model 406. The processor 403 may be implemented by one or more processors that execute instructions stored in the memory 404. Alternatively, some or all of the processor 403 may be implemented using dedicated circuitry, such as an application specific integrated circuit (ASIC), a graphics processing unit (GPU), or a programmed field programmable gate array (FPGA).

The ML model 406 is trained to perform one or more tasks and is executable by the processor 403. For example, the processor 403 could execute the ML model 406 to perform at least a portion of the analytics 132 in the e-commerce platform 100. In some embodiments, more than one ML model is stored in the memory 404. The ML model 406 could be implemented using any form or structure known in the art. Example structures for the ML model 406 include but are not limited to:
one or more artificial neural network(s);
one or more decision tree(s);
one or more support vector machine(s);
one or more Bayesian network(s); and/or
one or more genetic algorithm(s).

The ML platform 402 also includes an ML model training engine 410. The ML model training engine 410 includes a processor 412 and memory 414 storing an ML model 416 and data 418. The processor 412 may be implemented by one or more processors that execute instructions stored in the memory 414. Alternatively, some or all of the processor 412 may be implemented using dedicated circuitry, such as an ASIC, a GPU, or an FPGA. The processor 412 executes operations related to training the ML model 416 using the data 418.

The ML model 416 is stored by the memory 414 for the purposes of training, and is in what may be referred to as a “training mode”. In other words, the ML model 416 is not being applied to generate predictions or make decisions. Rather, the ML model 416 is being trained to generate improved predictions or decisions. In some implementations, the ML model 416 is generated and trained by the ML model training engine 410. In other implementations, the ML model training engine 410 is obtained from another component and is then trained by the ML model training engine 410. The memory 414 can store multiple ML models for the purposes of training.

The data 418 includes data samples used for training the ML model 416. Each data sample includes input data and a known result. By way of example, the data samples could include measurements, images, audio recordings, and text. The data samples could be obtained in any of a variety of different ways. In some implementations, data samples are collected from users of the ML platform 402. For example, when the ML platform 402 is implemented in an e-commerce platform, the data samples can be collected from merchants and customers using the e-commerce platform. In the example of the e-commerce platform 100, the data 418 may represent a portion of the data facility 134. In some implementations, data samples are collected by a third party and then received by the ML platform 402. As new data samples become available to the ML platform 402, the new data samples can be added to the data 418. In some implementations, older data samples are deleted as new data samples become available.

The method used to train the ML model 416 is implementation specific, and is not limited herein. Non-limiting examples of training methods include:
supervised learning;
unsupervised learning;
reinforcement learning;
self-learning;
feature learning; and
sparse dictionary learning.

According to some embodiments, the ML model training engine 410 trains the ML model 416 using supervised learning. In supervised learning, training is performed by analyzing input data in a data sample, making quantitative comparisons, and cross-referencing conclusions with a known result in the data sample. Iterative refinement of these analyses and comparisons allows the ML model training engine 410 to achieve greater certainty between the result predicted by the ML model 416 and the known result. This process is continued iteratively until the solution converges or reaches a desired accuracy.

According to other embodiments, the ML model training engine 410 trains the ML model 416 using unsupervised learning. In unsupervised learning, the ML model training engine 410 determines and draws its own connections from the data 418. This can be done by looking into naturally occurring data relationships or patterns in the data 418. One method for implementing unsupervised learning is cluster analysis, in which the goal is to discover groups or clusters within the data 418. A cluster is a set of variables that are treated similarly by an ML model. In cluster analysis, the ML model training engine 410 will subdivide the data 418 to determine clusters that have high intra-group similarities and low inter-group similarities. By way of example, cluster analysis may determine that certain products are associated with high rates of fraud in an e-commerce platform. The number of clusters used in a cluster analysis may be configurable in the ML model training engine 410.

In some embodiments, certain terminology is removed from textual data samples before training using cluster analysis. This might inhibit the generation of undesirable clusters. By way of example, consider the following textual data samples:
“He is an astronaut, he is on Venus”;
“He is an accountant, he is on Earth”; and
“She is an astronaut, she is on Mars.”

Using these data samples to train an ML model using cluster analysis could result in gendered clustering. If gendered terminology is removed from the data samples, the data samples become:
“is an astronaut, is on Venus”;
“is an accountant, is on Earth”; and
“is an astronaut, is on Mars.”

These data samples would not result in gendered clustering and might instead result in job clustering. While both gender and job clusters are valid, job clustering might be more desirable for certain applications. For example, if an ML model is trained to recommend employees for jobs, job clustering is preferable. Accordingly, data samples that are used for training can be modified to produce more desirable clusters in cluster analysis.

After training in the ML model training engine 410, the ML model 416 could be copied or transferred to the memory 404 for use by the ML platform 402. For example, the ML model 406 could be the ML model 416 after training. The ML model 416 could also or instead be transferred to an ML model test engine to test the accuracy and reliability of the ML model.

The ML platform 402 includes an ML model test engine 420, which could be similar to the ML model test engine 300 of FIG. 3, for example. The ML model test engine 420 includes a processor 422 and memory 424 storing an ML model 426 and data 428. The processor 422 may be implemented by one or more processors that execute instructions stored in the memory 424. Alternatively, some or all of the processor 422 may be implemented using dedicated circuitry, such as an ASIC, a GPU, or an FPGA. The processor 422 executes operations related to testing the ML model 426 using the data 428.

The ML model 426 is stored by the memory 424 for the purposes of testing, and is in what may be referred to as a “test mode”. In other words, the ML model 426 is not being applied to generate predictions or make decisions. Rather, the ML model 426 is being tested to assess the performance of the ML model 426. The ML model 426 may be tested for accuracy and/or non-causal dependencies. The memory 424 can store multiple ML models for the purposes of testing.

In some implementations, the ML model 416 is trained in the ML model training engine 410 before being transferred or copied to the ML model test engine 420 for testing. Once the ML model test engine 420 determines that the ML model 426 is suitable for use, the ML model 426 could be transferred to the memory 404 for use in the ML platform 402. As such, the ML model 426 could be the ML model 416 after training, and the ML model 406 could be the ML model 426 after testing.

Optionally, the ML model 406 is periodically copied to the ML model test engine 420 to ensure that the ML model 406 is still accurate and/or non-causally dependent. In this case, the ML model 426 is a copy of the ML model 406. An ML model can be used by the ML platform 402 while the ML model is also being tested by the ML model test engine 420.

The data 428 includes data samples used for testing the ML model 426. The data samples include input data and optionally include known results. As explained in further detail below, a data sample might only include input data and might not include a known result. At least some of the data samples in the data 428 could be similar to, or the same as, data samples in the data 418. In some embodiments, a data set is split between the data 418 and the data 428. For example, the data 418 could include 80% of the data samples in the data set, and the data 428 could include the remaining 20% of the data samples. As such, the ML model 416 is trained using 80% of the data samples, and the ML model 426 is tested using 20% of the data samples.

As new data samples become available to the ML platform 402, the new data samples can be added to the data 428. In some implementations, older data samples are deleted as new data samples become available. When new data is obtained and added to the data 428, the ML model 406 may be retested to ensure that the ML model 406 is still accurate in view of the new data. For example, when the ML platform 402 is implemented in an e-commerce platform, new data may represent changes in customer behaviour that are not reflected in the older data samples, and therefore are also not reflected in the ML model 406. The ML model 406 may need to be retrained to capture the changes in customer behaviour.

The ML model test engine 420 can test the accuracy of the ML model 426 by comparing the results that the ML model 426 produces to known results. Using a data sample in the data 428, the ML model test engine 420 provides input data to the ML model 426. The result produced by the ML model 426 is then compared to the known result. If the result produced by the ML model 426 substantially matches the known result, then the ML model 426 is considered to have passed the test. The ML model test engine 420 might test the ML model 426 using multiple data samples before concluding that the ML model 426 is accurate. If the result produced by the ML model 426 does not match the known result within a predetermined threshold, for example, the then ML model 426 is considered to have failed the test. After the ML model 426 fails one or more tests, the ML model test engine 420 could send the ML model 426 back to the ML model training engine 410 to be retrained.

The data 428 also includes non-causal data that is used to test the ML model 426 for non-causal dependencies. The form of the non-causal data may depend on the type of non-causal dependency that is being tested for. Non-limiting examples of non-causal data include:
noise, such as artificial noise that can be used to simulate a degradation in signal quality;
biased values, such as audio frequencies or colors that may affect the analysis of a measurement; and
biased terminology, such as gendered, racial, ethnic and religious terminology.

In some implementations, the non-causal data is manually generated. For example, an operator could generate a list of biased terminology that can be used to test for a bias in the ML model 426. In other implementations, the non-causal data is automatically generated. The non-causal data in the data 428 may be updated periodically or intermittently.

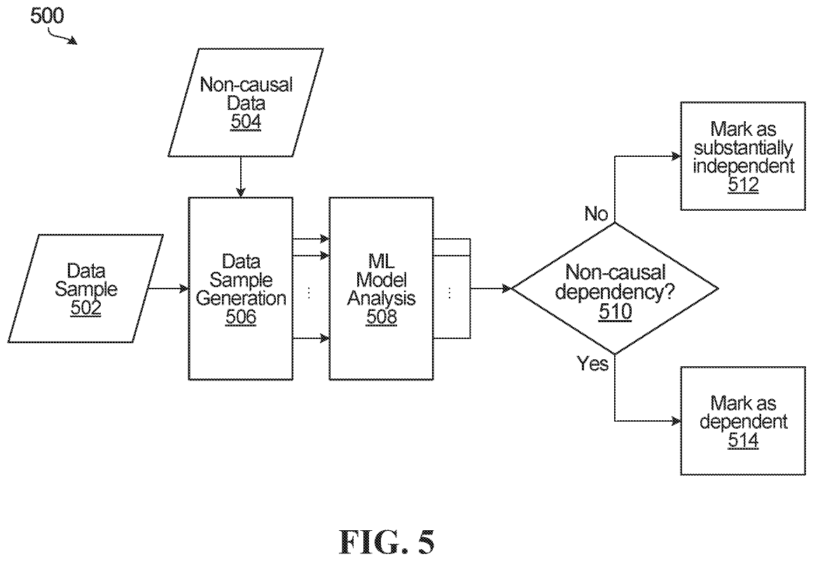

Using non-causal data, the ML model test engine 420 tests the ML model 426 for non-causal dependencies. As explained above, non-causal dependencies can degrade the performance, accuracy and/or impartiality of an ML model. FIG. 5 is a flow diagram illustrating an example process 500 for detecting a non-causal dependency in an ML model. The process 500 includes a data sample 502, non-causal data 504, data sample generation 506, ML model analysis 508, a comparison 510, and two decisions 512, 514. The process 500 will be described as being performed by the ML platform 402; however, other implementations of the process 500 are also contemplated.

The data sample 502 and the non-causal data 504 are obtained from the data 428. The data sample 502 includes input data and optionally includes a known result. The non-causal data 504 has a non-causal relationship to the output of the ML model 426. The data sample 502 and the non-causal data 504 are both inputs to the data sample generation 506. The data sample generation 506, which is implemented at least in part using the processor 422, generates multiple data samples from the data sample 502. At least one of these multiple data samples is a modified data sample that differs from the data sample 502 by the non-causal data 504. In some implementations, more than one of the multiple data samples are modified data samples. A modified data sample may be generated by adding or removing the non-causal data 504 from the data sample 502. Adding or removing non-causal data in a data sample is referred to herein as “polluting” the data sample. The multiple data samples that are produced by the data sample generation 506 can include an unmodified copy of the data sample 502, but this might not always be the case. In some cases, the multiple data samples are all modified in a different manner using the non-causal data 504.

In one example, the data sample 502 is a document including text, and the non-causal data 504 is biased terminology. To generate modified data samples, the biased terminology is added or removed from the text of the document. One modified data sample could be generated by removing female terminology (for example, “her”, “hers” and “she”) from the document, and/or adding male terminology (for example, “him”, “his” and “he”) to the document. Another modified data sample could be generated by adding female terminology to the document, and/or removing male terminology from the document.

In another example, the data sample 502 is a measurement, and the non-causal data 504 is noise. To generate the modified data sample, the noise could be added or removed from the measurement. Noise generally corresponds to any data that is undesirable in the measurement. Noise is not limited to white noise or random noise. For example, in the case of a measurement including an audio recording, noise could be background sounds that are not intended to be recorded. In the case of a measurement including an image, noise could be additional content in the image that distracts from the focus of the image.

In yet another example, the data sample 502 is a measurement, and the non-causal data 504 is a biased value. To generate the modified data sample, the biased value of the measurement could be modified. Modifying the biased value changes one or more characteristics of the measurement, without substantially affecting the causal data in the measurement. The way in which the biased value is modified may be dependent on the form of the biased value and/or the form of the measurement. In one example, the biased value is the pitch of a voice in an audio recording. To modify the biased value, the voice in the recording could be tuned to higher or lower frequencies. In another example, the biased value is the background color of an image. To modify the biased value, the background color could be adjusted to a different color.

In some implementations, after the multiple data samples are produced, the multiple versions of the data sample are stored in the data 428. The multiple data samples could be stored for later use.

The ML model analysis 508 corresponds to the ML model 426 being executed by the processor 422. As illustrated using multiple arrows between the data sample generation 506 and the ML model analysis 508, the multiple data samples are sent from the data sample generation 506 to the ML model analysis 508. The ML model analysis 508 inputs each data sample into the ML model 426 to generate a respective result. The multiple results are then input into the comparison 510. The multiple results produced by the ML model analysis 508 could also be stored in the data 428.

The comparison 510 compares the multiple results to each other and is implemented using the processor 422. In some cases, the multiple results are also compared to a known result for the data sample 502. However, this might not always be the case. In some implementations, the data sample 502 does not include a known result, or the known result is ignored by the comparison 510.

The comparison 510 determines whether or not the machine learning model 426 is dependent on the non-causal data 504. In some cases, the comparison 510 determines that the ML model 426 is substantially independent of the non-causal data 504, and the process 500 proceeds to the decision 512. In the decision 512, the ML model 426 is marked as being substantially independent of the non-causal data 504. In some embodiments, the ML platform 402 stores an indication that the ML model 426 is substantially independent of the non-causal data 504. Such an indication could be stored in the memory 404 and/or the memory 424, for example. The indication could confirm that the ML model 426 is suitable for use in the presence of the non-causal data 504.

Determining, based on a comparison of the multiple results produced by the ML model analysis 508, that the ML model 426 is substantially independent of the non-causal data 504 could occur in any number of different ways. According to one example, if the result corresponding to a modified data sample is substantially similar to a result corresponding to the unmodified data sample 502, then the ML model 426 is substantially independent of the non-causal data 504. According to another example, if the result corresponding to a modified data sample is substantially similar to a known result for the data sample 502, then the ML model 426 is likely substantially independent of the non-causal data 504. According to a further example, if the result corresponding to a modified data sample is substantially similar to the result corresponding to a differently modified data sample, then the ML model 426 is likely substantially independent of the non-causal data 504. In this further example, there is a chance that the two differently modified data samples produce similar results even when the ML model 426 is dependent on the non-causal data 504 because the modifications to the data samples affect the result of the ML model 426 similarly. Therefore, a match between the results corresponding to differently modified data samples might not be a guarantee that the ML model 426 is substantially independent of the non-causal data 504.

An ML model being substantially independent of non-causal data means that any dependence the ML model might have on the non-causal data does not render the ML model unsuitable for use in the presence of the non-causal data. In an example, an ML model being substantially independent of non-causal data means that the ML model can still achieve a desired accuracy even in the presence of the non-causal data. In another example, an ML model being substantially independent of non-causal data means that the ML model will not prejudice any groups over others.

In some cases, the comparison 510 determines that the ML model 426 is dependent on the non-causal data 504, and the process 500 proceeds to the decision 514. In the decision 514, the ML model 426 is marked as being dependent on the non-causal data 504. In some embodiments, the ML platform 402 stores an indication that the ML model 426 is dependent on the non-causal data 504. Such an indication could be stored in the memory 404 and/or the memory 424, for example. The indication could warn that the ML model 426 is not suitable for use in the presence of the non-causal data 504. The indication could also designate the ML model 426 for modification. In some embodiments, the ML platform 402 stores an indication that the non-causal data 504 is associated with non-causal dependencies. Such an indication could be stored in the memory 404 and/or the memory 424, for example. The indication could warn that other ML models should possibly be tested for a dependency on the non-causal data 504.

Determining, based on a comparison of the multiple results produced by the ML model analysis 508, that the ML model 426 is dependent on the non-causal data 504 could occur in any number of different ways. According to one example, if the result corresponding to a modified data sample differs from the result corresponding to the unmodified data sample 502, then the ML model 426 is dependent on the non-causal data 504. According to another example, if the result corresponding to a modified data sample is different from the result corresponding to a differently modified data sample, then the ML model 426 is dependent on non-causal data 504. According to a further example, if the result corresponding to a modified data sample is different from a known result for the data sample 502, then the ML model 426 might be dependent on the non-causal data 504. However, in this further example, the ML model 426 might not be dependent on the non-causal data 504. Instead, the ML model 426 might simply be inaccurate. In other words, the ML model 426 would not produce the known result even using the unmodified data sample 502. Therefore, if the result corresponding to the modified data sample is different from the known result for the data sample 502, further steps should be taken to determine if this is due to a non-causal dependency. For example, the unmodified data sample 502 could be input into the ML model 426, and the generated result can be compared to the known result. Accordingly, at least two different versions of a data sample should be tested in an ML model to determine if the ML model has a non-causal dependency.

An ML model being dependent on non-causal data means that the ML model is unsuitable for use in the presence of the non-causal data. In an example, an ML model being dependent on non-causal data means that the ML model might not achieve a desired accuracy in the presence of the non-causal data. In another example, an ML model being dependent on non-causal data means that the ML model might prejudice certain groups.

When the ML model 426 is determined to have a dependency on the non-causal data 504, the ML model can be updated, restructured, retrained and/or otherwise modified to reduce or remove the dependency. This could include returning the ML model 426 to the ML model training engine 410 for retraining or restructuring, for example.

In some embodiments, a non-causal dependency is removed from an ML model by retraining the ML model with new training data. The new training data may be collected, selected and/or modified to specifically avoid training a dependency on non-causal input data into the ML model. For example, if an ML model is determined to be dependent on gendered terms, then the new training data may be chosen with the goal of reducing a gender bias. After training with the new training data, the ML model could be retested for a gender bias.

In some embodiments, retraining an ML model includes modifying a set of training data samples to remove any data associated with non-causal data and produce modified training data samples. Retraining the machine learning model is then performed using the modified training data samples. For example, an ML model may be modified such that non-causal data is filtered from its training data samples when retraining. During use of the modified ML model, the non-causal data is also filtered from received data samples. Consider an ML model that is determined to be dependent on gendered terms. Any or all gendered terms in a data sample could be designated as “stop words” in the ML model, which are filtered out before processing by the ML model.

In some embodiments, an ML model implements cluster analysis, and a non-causal dependency is removed from the ML model by retraining the ML model with a different number of clusters. The number of clusters in the ML model may be manually updated, and the ML model is then retrained with the new number of clusters. Changing the number of clusters can help remove undesirable dependencies from the ML model. By way of example, a cluster might combine gendered terms to remove a gender bias from the ML model. A cluster could include the words “waiter” and “waitress”, and treat these words similarly in the ML model. In some embodiments, training data samples can be modified to generate more desirable clusters, as outlined above.

In some embodiments, an ML model implements a neural network, and a non-dependency is removed from the ML model by restructuring the neural network with a different number of nodes and/or a different number of nodal layers. The restructured neural network is then retrained.

After modifying an ML model to remove a non-causal dependency, the modified ML model could be retested for the non-causal dependency using a second iteration of the process 500. The second iteration of the process 500 could use the same data sample 502 and/or the same non-causal data 504. Moreover, the multiple data samples that were generated by the data sample generation 506 could be reused in the second iteration of the process 500. However, the second iteration could instead use a different data sample 502 and/or different non-causal data 504.

It should be noted that an ML model might not always be retrained and/or modified after determining that the ML model is dependent on non-causal data. Knowledge of the non-causal dependency might be all that is required. In some cases, use of the ML model can be restricted to situations in which the ML model will not analyse the non-causal data. For example, if an ML model is known to have a gender bias, and gendered terminology is detected in a text data sample, then the ML model might not be used to analyse the text data sample.

The process 500 might test the ML model 426 using multiple different data samples and/or a variety of non-causal data. In some implementations, the same non-causal data is used to pollute multiple different data samples, to perhaps more thoroughly test for a dependency on the non-causal input data. In some implementations, the same data sample is polluted using different types of non-causal data to test for different non-causal dependencies. In some implementations, each data sample in a set of X data samples is polluted using a set of Y different types of non-causal data. In these implementations, a total of Xx Y different non-causal dependency tests are performed.

Referring again to FIG. 4, the ML platform 402 further includes a network interface 430. The network interface 430 is provided to enable communication over the network 440. The structure of the network interface 430 is implementation specific. For example, in some implementations the network interface 430 may include a network interface card (NIC), a computer port (e.g., a physical outlet to which a plug or cable connects), and/or a network socket.

It should be noted that the ML platform 402 is provided by way of example. Other ML platforms could be implemented differently. Although the ML model training engine 410 and the ML model test engine 420 are illustrated as distinct components in the ML platform 402, an ML model training engine and an ML model test engine could instead be implemented as a single component including a single memory and/or a single processor. A combined ML model training and test engine could store one version of an ML model that is trained and then tested. The data 418 and the data 428 could also be combined into a single data set that includes both training and test data. In some embodiments, any two or more of the memories 404, 414, 424 are combined as a single memory that stores an ML model and/or data. In some embodiments, any two or more of the processors 403, 412, 422 are combined as a single processor. Moreover, the functionality of the ML model test engine 420 may be divided between multiple engines. The ML model test engine 420 might only test ML models for non-causal dependencies, while another engine tests the accuracy of ML models using known results. Other variations of the ML platform 402 are also contemplated.

The user device 450 of the system 400 may be a mobile phone, tablet, laptop, or computer owned and/or used by a user. In some implementations, the user device is a customer device or a merchant device, such as the customer device 150 and merchant device 102 of FIGS. 1 to 3, for example. The user device 450 includes a processor 452, memory 454, user interface 456 and network interface 458. An example of a user interface is a display screen (which may be a touch screen), a keyboard, and/or a mouse. The network interface 458 is provided for communicating over the network 440. The structure of the network interface 458 will depend on how the user device 450 interfaces with the network 440. For example, if the user device 450 is a mobile phone or tablet, the network interface 458 may include a transmitter/receiver with an antenna to send and receive wireless transmissions to/from the network 440. If the merchant device is a personal computer connected to the network with a network cable, the network interface 458 may include, for example, a NIC, a computer port, and/or a network socket. The processor 452 directly performs or instructs all of the operations performed by the user device 450. Examples of these operations include processing user inputs received from the user interface 456, preparing information for transmission over the network 440, processing data received over the network 440, and instructing a display screen to display information. The processor 452 may be implemented by one or more processors that execute instructions stored in the memory 454. Alternatively, some or all of the processor 452 may be implemented using dedicated circuitry, such as an ASIC, a GPU, or a programmed FPGA.

The user device 450 may communicate with the ML platform 402 via the network 440 to access the functionality provided by the ML platform 402. For example, if the ML platform 402 is an e-commerce platform, then the user device 450 could be a customer device that is used to browse an online store. In some embodiments, the ML platform 402 receives a data sample from the user device 450 using the network interface 430 and the processor 403. This data sample may be analysed using the ML model 406. However, if the ML model 406 was found to have a dependency on non-causal data, then the ML platform 402 may first perform steps to determine if the data sample includes data that is associated with the non-causal data. Data associated with the non-causal data includes any data expected to have the same non-causal relationship to the output of the ML model as the non-causal data that has previously been tested. For example, if the previously tested non-causal data includes certain gendered terminology, then data that is associated with the non-causal data could include any type of gendered terminology.

Determining if a data sample includes non-causal data could be performed in any of a number of different ways. In some embodiments, the ML platform 402 actively compiles a set of non-causal data based on the results of the ML model test engine 420. For example, whenever the process 500 determines that an ML model is dependent on particular non-causal data, then this particular non-causal data is added to a growing set of non-causal data. The set of non-causal data could be stored in the memory 404, for example. Any user input data samples could then be compared against the set of non-causal data to determine if the user data samples include non-causal data.

In some embodiments, a user data sample is compared against a predetermined set of non-causal data to determine if the user data sample includes non-causal data. It should be noted that this non-causal data might not have been tested using the process 500. Therefore, these embodiments could be performed independently of the process 500.

When the data sample received from the user device 450 includes non-causal data, the ML platform 402 may perform steps to mitigate the impact of the non-causal data. The steps may be performed by the processor 403.

According to some embodiments, when a data sample received from the user device 450 includes non-causal data, the ML platform 402 transmits, to the user device 450, an indication that the ML model 406 is dependent on the non-causal data. The indication might not be an explicit statement that the ML model 406 is dependent on that non-causal data. Rather, the indication could be simply a message notifying the user that the results might not be as fair or accurate as usual.

According to some embodiments, when a data sample received from the user device 450 includes non-causal data, the ML platform 402 transmits, to the user device 450, an indication that the data sample includes the non-causal data. The ML platform 402 may further transmit, to the user device 450, an indication that the ML model 406 has been tested and/or modified to ensure that the non-causal data will not substantially affect the output of the ML model. Knowing that the data sample includes the non-causal data may influence how the user will handle or manage the user data sample. In some implementations, the user may choose not to analyse the data sample using other ML models that might be dependent on the non-causal data (i.e., models that have not been tested for a dependency on the non-causal data). By way of example, the ML platform 402 may transmit an indication that a user data sample includes text associated with a particular religion, and optionally an indication that some ML models will be dependent on this text. The user may then decide to avoid analysing the data sample in ML models that have not been tested for a dependency on text associated with religion.

According to some embodiments, the ML model 406 is modified such that data associated with non-causal data is filtered or removed from its training data samples during retraining. When a data sample received from the user device 450 also includes non-causal data, the ML platform 402 would also modify the data sample to remove or filter the data associated with the non-causal data and to produce a modified data sample. A result can then be generated by inputting the modified data sample into the ML model 406. This result may then be transmitted to the user device 450. It should be noted that filtering non-causal data from training data samples and user data samples could be performed automatically by an ML model. For example, non-causal terms could be designated as stop words in an ML model, where these terms are filtered from any data sample processed using the ML model. Filtering terms from a data sample may also be referred to as “cleaning” the data sample.

Consider, for example, a case in which the ML platform 402 is configured to receive a picture of a person and determine, using the ML model 406, the age of the person in the picture. The user device 450 can transmit a picture of a person to the ML platform 402, and the ML model 406 analyses the picture and outputs an estimate of the person's age. The estimate of the person's age is then transmitted to the user device 450. It may have been determined, using the process 500 for example, that the ML model 406 was originally dependent on whether or not the picture includes a person wearing a hat. This is an example of a non-causal dependency in the ML model 406, as there is no causal relationship between a person's age and whether they are wearing a hat in a photograph. The ML model 406 has been retrained by removing the hats from the training data samples. When the ML platform 402 receives a data sample in the form of a picture of a person, the ML platform 402 could determine if the person in the picture is wearing a hat. This determination could be performed by a dedicated ML model stored on the memory 404 in some implementations. If the picture does include a person wearing a hat, then the ML platform 402 could transmit any of the following messages to the user device 450 upon receipt of the picture:
“We noticed that you are wearing a hat in the picture. Our estimates tend to be less accurate when you are wearing a hat”; and
“Please take another picture without your hat on”.

Alternatively, if the picture includes a person wearing a hat, then the ML platform 402 could modify the picture to remove the hat. For example, the ML platform 402 could crop the picture to remove the portion of the picture that includes the hat. This could reduce or remove the impact of the hat on the analysis of the picture by the ML model 406.

In FIG. 4, one user device is shown by way of example. In general, more than one user device may be in communication with an ML platform engine 402.

The system 400 and the process 500 could be used in any of a variety of different applications. Some specific examples of such applications are provided below. These examples are meant to be illustrative and should not be considered limiting in any way. Fraudulent orders in an e-commerce platform

An ML model can be trained to predict the risk of fraudulent orders being placed for certain products on an e-commerce platform. The ML model can receive input data including a product description and output an estimated risk of fraud. This information can help a merchant modify their product descriptions in order to reduce the risk of receiving fraudulent orders.

The e-commerce platform could test the ML model for a gender bias using the process 500 of FIG. 5, for example. Starting with a data sample that includes a product description, two versions of the data sample are generated. One version is polluted with male terminology, and another version is polluted with female terminology.

By way of example, an unmodified data sample could be:
This child seat is great for children from ages 1 to 5. Your child will be comfortable in the soft yet spill-resistant seat. A parent can also be at ease knowing that their child will not accidentally fall from the seat. The child seat is suitable for boys and girls.

After pollution with gendered terminology, a first modified data sample could be:
This child seat is great for girls from ages 1 to 5. Your daughter will be comfortable in the soft yet spill-resistant seat. A mother can also be at ease knowing that her daughter will not accidentally fall from the seat. The child seat is suitable for girls.

A second modified data sample could be:
This child seat is great for boys from ages 1 to 5. Your son will be comfortable in the soft yet spill-resistant seat. A father can also be at ease knowing that his son will not accidentally fall from the seat. The child seat is suitable for boys.

Each version of the data sample (the unmodified data sample, first modified data sample and second modified data sample) is input into the ML model to produce a result, and the respective results are compared. Any disparity between the predicted risk of fraud for each version of the data sample is indicative of a gender bias in the ML model. Since gender is an example of non-causal data for predicting the risk of fraud, a gender bias in the ML model would be considered a non-causal dependency.

After detecting a gender bias in the ML model, any of a number of different actions could be taken. In some embodiments, the ML model is modified to reduce or remove the gender bias. Modifying the ML model could include, but is not limited to:
Retraining the ML model with different training data to reduce or remove the gender bias; and
Restructuring the ML model data to reduce or remove the gender bias.

In some embodiments, after detecting a gender bias in the ML model, product descriptions that are received by the e-commerce platform for analysis by the ML model are first analysed for gendered terminology before inputting the product descriptions into the ML model. If gendered terminology is discovered in a product description, then content may be transmitted to the merchant that submitted the product description. This content could include an indication that the e-commerce platform performs analytics that may be affected by gendered terminology. The content could further provide an option to resubmit the product description with less gendered terminology.

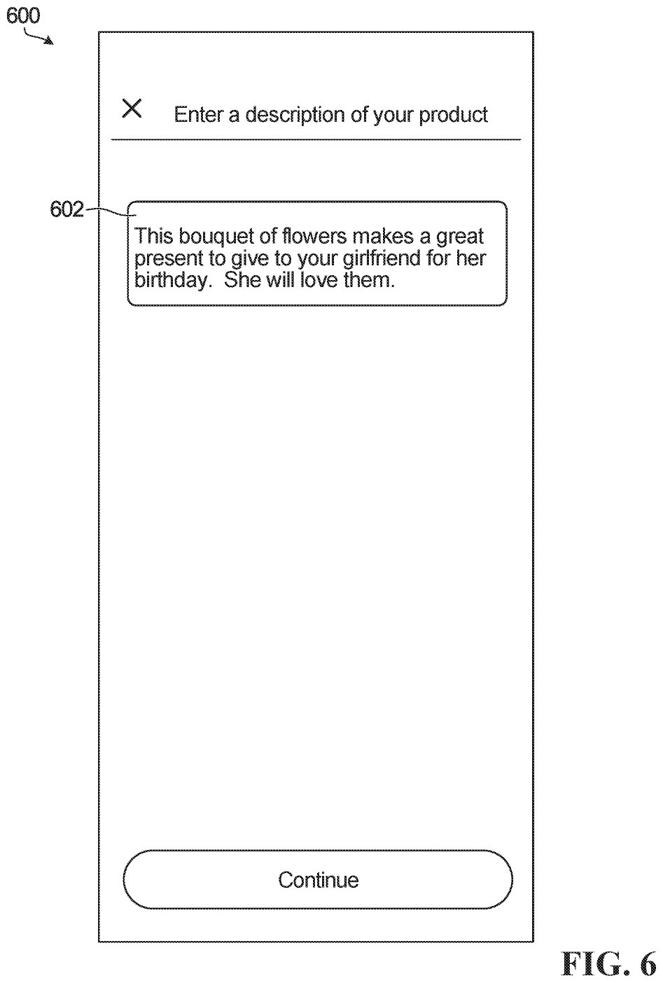

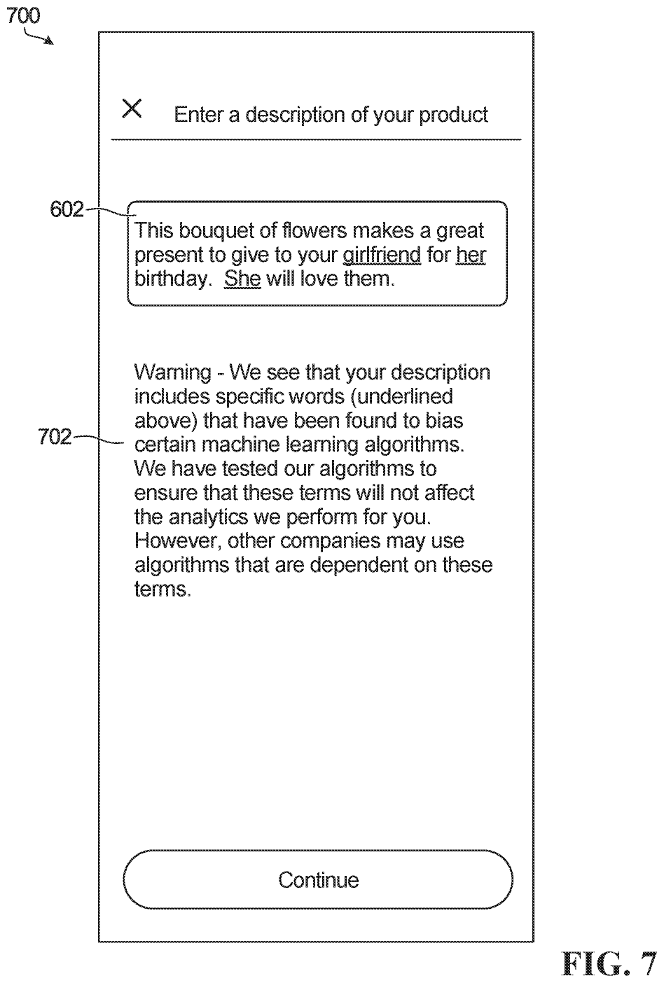

FIG. 6 is an example screen page 600 for submitting a product description 602. The screen page 600 may be displayed on a merchant device to a merchant that is adding a new product to their online store, for example. The product description 602 is assessed by an e-commerce platform for a risk of fraud using the ML model described above. Before a merchant submits the product description 602, the product description 602 is analysed to detect any gendered terminology that is known to be associated with a non-causal dependency. Upon detection of such gendered terminology, a warning is displayed to the merchant. FIG. 7 is an example screen page 700 including the product description 602 and an indication 702 that the product description includes terminology that can cause bias in machine algorithms. The indication 702 informs the merchant that the algorithms used by the e-commerce platform have been tested for, and determined to be free of, a dependency on gendered terminology using the process 500, for example. The indication 702 further informs the user that other algorithms might be dependent on gendered terminology. In some implementations, the screen page 700 could further include an offer (not shown) to the merchant to test other algorithms for any dependency on gendered terminology. Based on the result of the test, the merchant could decide whether or not to use the other algorithms to analyse the product description 602.

Gender bias is only one example of a non-causal dependency that the ML model could be tested for. The ML model could also be tested for a dependency on age, ethnicity, sexual orientation, marital status, and religion, for example.

### Loan Eligibility in a Financial Platform

An ML model can be trained to predict the risk of a customer defaulting on a loan. In some embodiments, the ML model is implemented on a financial platform operated by a bank. The output of the ML model is the risk that the customer will default on a loan, which the bank could use to determine whether or not to offer the customer the loan. The ML model can receive input data including information on the proposed loan and the customer's financial history. For example, the customer's job, income and credit history could be provided as inputs to the ML model. The ML model might also be provided with other text data including information on the customer.

The ML model could be trained using multiple data samples that each includes information on a respective loan and on a respective customer that received the loan. The information on the customer could include text data collected from records on the financial platform and elsewhere. Each data sample further includes a respective known result indicating whether or not the customer defaulted on the load.

Any text data that is used to train the ML model is a possible vector for the introduction of bias into the ML model. As such, the financial platform could test the ML model for bias using the process 500, for example. The ML model could be tested for the following bias genres:
ethnic genres using popular names from different communities (for example, Imani, Ebony or Shanice vs Molly, Amy or Claire, etc.);
gender using gendered terms; and
sexual orientation using terms (for example, homosexual vs heterosexual).

### Media Monetization in a Social Media Platform

In a social media platform that hosts user-generated videos, an ML model can be trained to decide which videos are eligible for monetization and which videos are not eligible for monetization. Being eligible for monetization means that advertisements can be attached to the video, which generates revenue for the video's creator. The social media platform might want to analyse a video to ensure that it meets certain requirements before making the video eligible for monetization. For example, the social media platform might want to discourage the creation of violent content by making videos that include violence ineligible for monetization. The ML model implemented by the social media platform could analyse a video's title and description to determine if it meets certain requirements for monetization.

A set of training data samples for the ML model could include the title and description of videos that were deemed ineligible for monetization and the title and description of videos that were deemed eligible for monetization. These training data samples could inadvertently introduce bias into the ML model. In an example, the trained ML model is prejudiced against LGBT+-themed videos, which would disadvantage content producers from LGBT+ communities.

The process 500 of FIG. 5 could be applied to detect a bias against LGBT+-themed videos in the ML model. For example, a data sample including a generic video title and description could be obtained. One copy of the data sample could then be polluted with LGBT+ terminology, and another copy of the data sample could be polluted with heterosexual terminology. If the data sample polluted with LGBT+ terminology is determined by the ML model to be ineligible for monetization, whereas the data sample polluted with heterosexual terminology is determined by the ML model to be eligible for monetization, then the ML model has a bias against LGBT+-themes. This could be corrected by retraining the ML model using a new set of training data samples.

### Non-Causal Data in Audio Samples

Detecting non-causal dependencies is in no way limited to textual data samples. Consider an ML model that is used for audio recognition. The ML model receives an audio recording including a voice and outputs the words that are spoken by the voice. The process 500 of FIG. 5 could be used to determine if the ML model is capable of ignoring non-causal data in the audio recording, such as an irrelevant or useless signal. Non-causal data in an audio recording could also be referred to as an audio bias. One example of non-causal data is background noise produced by the sound of a train running. The ML model could be tested using an audio signal with and without background noise to determine if the ML model is dependent on the background noise.

Accents are another example of non-causal data in an audio recording of a voice. An accent could be considered an audio bias value, which can be tested for using the process 500 of FIG. 5. For example, two audio recordings could be created, each audio recording being of a voice speaking the same sentence. One voice has a Scottish accent, and the other voice has an Australian accent. Each audio recording is input into the ML model. A comparison of the results generated by the ML model to each other and to the actual sentence being spoken could indicate a non-causal dependency in the ML model. For example, the ML model might exhibit relatively poor performance for the Scottish accent. In this case, the ML model might be retrained with audio samples that include more Scottish accents.

### Non-Causal Data in Image Samples

An example ML model is trained to provide a merchant with recommendations for improving the look of their online store on an e-commerce platform. These recommendations could include changes to a color scheme used in a webpage for the online store. In some implementations, a bias against users with colorblindness could be trained into the ML model. For example, the ML model could recommend color schemes that do not provide suitable contrast for those with colorblindness.

The ML model could be tested for a bias against those with colorblindness using the process 500 of FIG. 5, for example. A test data sample could include a particular webpage of an online store. The webpage could then be modified using one or more colorblind filters, to generate modified webpages that simulate what a colorblind person might see. Modifying a webpage with a colorblind filter is an example of modifying the webpage with non-causal data, as ideally the quality of a webpage should not be significantly reduced for a person with colorblindness.

The original and modified webpages are input into the ML model. If the ML model produces a similar recommendation for each webpage, then the ML model likely does not disadvantage those with colorblindness. However, if the ML model produces different recommendations for each webpage, then the ML model might be producing recommendations that disadvantage those with colorblindness. The ML model could then be retrained using data that better reflects webpages that are preferred by colorblind customers, for example.

### General Example

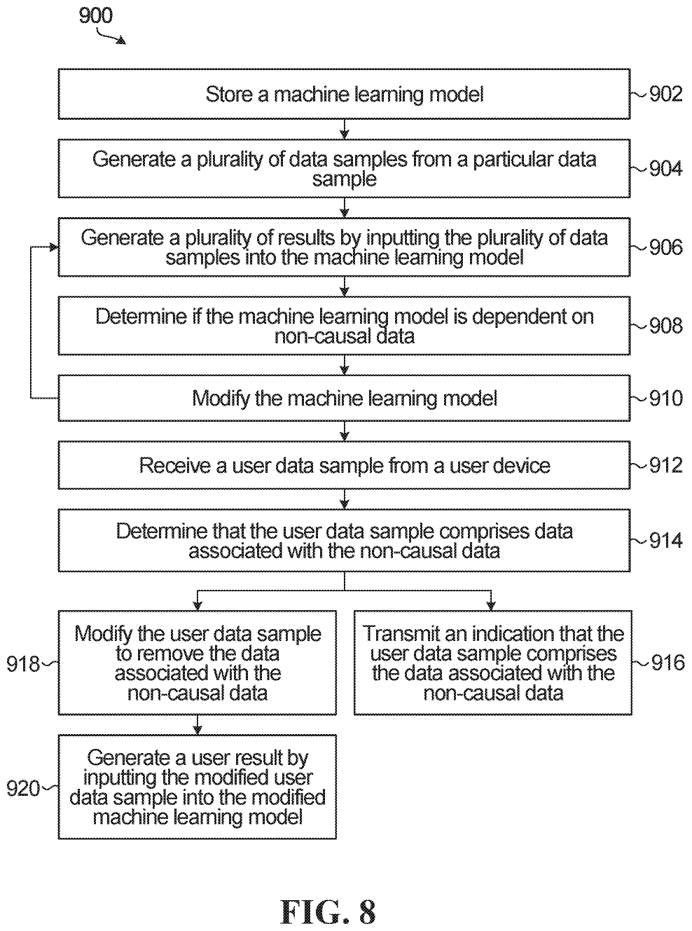

FIG. 8 is a flow diagram illustrating an example computer-implemented method 900 performed by a system. In some implementations, the method 900 is performed by the system 400 of FIG. 4. However, other systems could also or instead perform the method 900. The method 900 could be applied to any of a number of different applications, including e-commerce, finance and social media, for example.

Step 902 includes storing an ML model defining a relationship between input data and an output. The ML model is stored in memory, such as the memory 424 of FIG. 4, for example. The ML model is trained to perform one or more tasks, examples of which can be found elsewhere herein.

Step 904 includes generating a plurality of data samples from a particular data sample. Optionally, before step 904, the method 900 includes a step (not shown) of obtaining the particular data sample. In some embodiments, the particular data sample is obtained from memory. In other embodiments, the particular data sample is obtained from another device or system. The plurality of data samples includes at least one modified data sample that differs from the particular data sample by non-causal data. The non-causal data has a non-causal relationship to the output of the ML model. In some embodiments, step 904 is similar to the function performed in the data sample generation 506 of FIG. 5, for example.

In some embodiments, the particular data sample includes text and the non-causal data includes biased terminology. In these embodiments, step 904 includes generating the modified data sample by adding or removing the biased terminology from the text. Biased terminology could include any words or phrases that are associated with a bias. For example, biased terminology might include words or phrases that exclude or prejudice a group, thing or person. Examples of biased terminology can be found elsewhere herein.

In some embodiments, the particular data sample includes a measurement and the non-causal data includes noise. In these embodiments, step 904 includes generating the modified data sample by adding or removing the noise from the measurement. The measurement could include an audio recording or an image, for example. The noise is not limited to white noise, and may be any signal component that is undesirable in, or irrelevant to, the measurement.

In some embodiments, the particular data sample includes a measurement and the non-causal data includes a biased value. In these embodiments, step 904 includes generating the modified data sample by modifying the biased value of the measurement. Non-limiting examples of biased values include accents in audio recordings and color schemes in images.

Step 906 includes generating a plurality of results by inputting the plurality of data samples into the ML model. Each of the plurality of results corresponds to a respective data sample of the plurality of data samples. In step 906, each of the plurality of data samples are separately input into the ML model, and the produced result is obtained and optionally stored. In some embodiments, step 906 is similar to the function performed in the ML model analysis 508 of FIG. 5, for example.

Step 908 includes determining, based on a comparison of the plurality of results, if the ML model is dependent on the non-causal data. The comparison can be performed in any of a number of different ways, which are discussed in detail elsewhere herein. In some embodiments, step 908 is similar to the function performed in the comparison 510 of FIG. 5, for example.

In some embodiments, step 908 determines that the machine learning model is substantially independent of the non-causal data. In these embodiments, the method 900 would end after step 908. The method 900 may then be repeated with a different ML model, a different data sample and/or different non-causal data.

In some embodiments, step 908 determines that the ML model is dependent on the non-causal data. In these embodiments, the method 900 may proceed to any or all of optional steps 910, 912, 914, 916, 918, 920.

Optional step 910 includes modifying the ML model to produce a modified ML model. In some embodiments, modifying the ML model includes retraining the ML model. Further examples of modifying an ML model can be found elsewhere herein. After the ML model is modified, the method 900 may return to step 906 to determine if the modified ML model is dependent on the non-causal data. For example, in the first iteration of steps 906, 908, the plurality of results is a first plurality of results and the comparison is a first comparison. In the second iteration of steps 906, 908, step 906 includes generating a second plurality of results by inputting the plurality of data samples into the modified ML model. Each of the second plurality of results corresponds to a respective data sample of the plurality of data samples. Step 908 then includes determining, based on a second comparison of the second plurality of results, if the modified ML model is dependent on the non-causal data. In the case that the modified ML model is determined to be dependent on the non-causal data, further iterations of steps 906, 908, 910 may be performed.

Optional step 912 includes receiving a user data sample from a user device. In an e-commerce platform, examples of user devices include merchant devices and customer devices. The data sample could be intended as an input to the ML model.

Optional step 914 includes determining that the user data sample includes data associated with, or similar to, the non-causal data. Data that is associated with the non-causal data includes any data that is expected to have the same or similar non-causal relationship to the output of the ML model as the non-causal data.

In one example, step 908 determined that the ML model is dependent on the gendered terms “he” and “she”. This could be interpreted as a detection of a gender bias in the ML model. The user data sample that is received in step 912 does not include the terms “he” and “she”, but does include the terms “waiter” and “waitress”. While the ML model was not tested for a dependency on the terms “waiter” and “waitress”, these terms are associated with the terms “he” and “she” in the sense that all of these terms are gendered. As such, one may presume that the ML model would also be non-causally dependent on the terms “waiter” and “waitress”. In this example, step 914 might determine that the terms “waiter” and “waitress” constitute data associated with the non-causal data. An exception would be if the ML model has previously been found to be substantially independent of the terms “waiter” and “waitress”.

In another example, step 908 could have determined that the ML model is dependent on the sound of a train in the background of an audio recording. The user data sample received in step 912 is an audio recording that includes the sound of birds in the background. The sound of birds is associated with the sound of a train at least in that they are both irrelevant background sounds. Therefore, unless the ML model has been specifically tested for a dependency on the sound of birds in the background of an audio recording, step 914 might determine that the sound of birds in the audio recording constitutes data associated with the non-causal data.

Following optional step 914, the method 900 could proceed to optional step 916. Optional step 916 includes transmitting, to the user device, an indication that the user data sample comprises the data associated with the non-causal data. An example of such an indication is the indication 702 of FIG. 7. The indication might advise the user of the user device not to analyse the user data sample in other algorithms unless the algorithms have been previously tested and determined to be substantially independent of the non-causal data.

In some implementations, step 910 includes retraining the ML model by modifying training data samples to remove data associated with the non-causal data and to produce modified training data samples, and retraining the machine learning model using the modified training data samples. These training data samples may be the same training data samples that produced the original ML model having a non-causal dependency. However, the non-causal dependency can be reduced or even removed in the ML model following training with the modified training data samples. In one example, non-causal gendered terminology could be removed from training data samples including text. In another example, the pitch could be adjusted to a single pitch for training data samples including an audio recording so that the high pitch of female voices and the low pitch of male voices is occluded. In a further example, images in training data samples could be cropped or colour-adjusted to remove extraneous non-causal data.

In the implementations where step 910 includes retraining the machine learning model using the modified training data samples, the method 900 may proceed from step 914 to optional step 918. Optional step 918 includes modifying the user data sample to remove the data associated with the non-causal data and to produce a modified user data sample. In general, the user data samples should be modified in the same manner as the training data samples in step 910. Referring to the examples provided above, non-causal gendered terminology could be removed from a user data sample including text; the pitch could be adjusted to a single pitch for a user data sample including an audio recording so that the high pitch of female voices and the low pitch of male voices is occluded; and an image in a user data sample could be cropped or colour-adjusted to remove extraneous non-causal data.

Optional step 920 includes generating a user result by inputting the modified user data sample into the modified ML model. As the ML model and the user data sample are modified to remove the data associated with the non-causal data, the user result should be unaffected by this data. The user result could then be used for any of a number of different purposes depending on the application. In some embodiments, at least a portion of the user result is transmitted to the user.

It should be noted that although step 916 and steps 918, 920 are shown on different paths of the method 900, all of the steps 916, 918, 920 could be performed in some implementations of the method 900.

Steps 904, 906, 908, 910, 912, 914, 916, 918, 920 are performed by a processor. In some embodiments, this processor is actually multiple processors that are provided by a system. For example, each of steps 904, 906, 908, 910, 912, 914, 916, 918, 920 could be performed by one or more of the processors 403, 412, 422 of FIG. 4.

### CONCLUSION

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A computer-implemented method comprising:
storing, in memory, a machine learning model defining a relationship between input data and an output;
generating a plurality of data samples from a particular data sample, the plurality of data samples comprising a modified data sample that differs from the particular data sample by non-causal data, the non-causal data having a non-causal relationship to the output;
generating a plurality of results by inputting the plurality of data samples into the machine learning model, each of the plurality of results corresponding to a respective data sample of the plurality of data samples; and
determining, based on a comparison of the plurality of results, if the machine learning model is dependent on the non-causal data.

2. The computer-implemented method of claim 1, wherein:
the particular data sample comprises text;
the non-causal data comprises biased terminology; and
generating the plurality of data samples comprises generating the modified data sample by adding or removing the biased terminology from the text.

3. The computer-implemented method of claim 1, wherein:
the particular data sample comprises a measurement;
the non-causal data comprises a biased value; and
generating the plurality of data samples comprises generating the modified data sample by modifying the biased value of the measurement.

4. The computer-implemented method of claim 1, further comprising:
receiving a user data sample from a user device;
determining that the user data sample comprises data associated with the non-causal data; and
transmitting, to the user device, an indication that the user data sample comprises the data associated with the non-causal data.

5. The computer-implemented method of claim 1, wherein determining if the machine learning model is dependent on the non-causal data comprises determining that the machine learning model is substantially independent of the non-causal data.

6. The computer-implemented method of claim 1, wherein determining if the machine learning model is dependent on the non-causal data comprises determining that the machine learning model is dependent on the non-causal data.

7. The computer-implemented method of claim 6, wherein the plurality of results is a first plurality of results and the comparison is a first comparison, the method further comprising:
modifying the machine learning model to produce a modified machine learning model;
generating a second plurality of results by inputting the plurality of data samples into the modified machine learning model, each of the second plurality of results corresponding to a respective data sample of the plurality of data samples; and
determining, based on a second comparison of the second plurality of results, if the modified machine learning model is dependent on the non-causal data.

8. The computer-implemented method of claim 7, wherein modifying the machine learning model comprises retraining the machine learning model.

9. The computer-implemented method of claim 8, wherein retraining the machine learning model comprises:
modifying training data samples to remove data associated with the non-causal data and to produce modified training data samples; and
retraining the machine learning model using the modified training data samples.

10. The computer-implemented method of claim 9, further comprising:
receiving a user data sample from a user device;
determining that the user data sample comprises further data associated with the non-causal data;
modifying the user data sample to remove the further data associated with the non-causal data and to produce a modified user data sample; and
generating a user result by inputting the modified user data sample into the modified machine learning model.

11. The computer-implemented method of claim 1, further comprising:
obtaining the particular data sample.

12. A system comprising:
memory to store a machine learning model defining a relationship between input data and an output; and
a processor to:
generate a plurality of data samples from a particular data sample, the plurality of data samples comprising a modified data sample that differs from the particular data sample by non-causal data, the non-causal data having a non-causal relationship to the output;
generate a plurality of results by inputting the plurality of data samples into the machine learning model, each of the plurality of results corresponding to a respective data sample of the plurality of data samples; and
determine, based on a comparison of the plurality of results, if the machine learning model is dependent on the non-causal data.

13. The system of claim 12, wherein:
the particular data sample comprises text;
the non-causal data comprises biased terminology; and
the processor is to generate the modified data sample by adding or removing the biased terminology from the text.

14. The system of claim 12, wherein:
the particular data sample comprises a measurement;
the non-causal data comprises a biased value; and
the processor is to generate the modified data sample by modifying the biased value of measurement.

15. The system of claim 12, wherein the processor is further to:
receive a user data sample from a user device;
determine that the user data sample comprises data associated with the non-causal data; and
transmit, to the user device, an indication that the user data sample comprises the data associated with the non-causal data.

16. The system of claim 12, wherein the machine learning model is substantially independent of the non-causal data.

17. The system of claim 12, wherein the machine learning model is dependent on the non-causal data.

18. The system of claim 17, wherein the plurality of results is a first plurality of results, the comparison is a first comparison, and the processor is further to:
modify the machine learning model to produce a modified machine learning model;
generate a second plurality of results by inputting the plurality of data samples into the modified machine learning model, each of the second plurality of results corresponding to a respective data sample of the plurality of data samples; and
determine, based on a second comparison of the second plurality of results, if the modified machine learning model is dependent on the non-causal data.

19. The system of claim 18, wherein the processor is further to retrain the machine learning model to produce the modified machine learning model.

20. The system of claim 19, wherein the processor is further to:
modify training data samples to remove data associated with the non-causal data and to produce modified training data samples; and
retrain the machine learning model using the modified training data samples to produce the modified machine learning model.

21. The system of claim 20, wherein the processor is further to:
receive a user data sample from a user device;
determine that the user data sample comprises further data associated with the non-causal data;
modify the user data sample to remove the further data associated with the non-causal data and to produce a modified user data sample; and
generate a user result by inputting the modified user data sample into the modified machine learning model.

22. The system of claim 12, wherein the processor is further to:
obtain the particular data sample.
